(19) United States
(12) Patent Application Publication
(10) Pub. No.: US 2004/0230433 A1
(43) Pub. Date: Nov. 18, 2004

(54) Microphone system

(76) Inventors: Wolfgang Niehoff, Wedemark (DE); Rolf Meyer, Wennigsen (DE)

Correspondence Address: REED SMITH, LLP, ATTN: PATENT RECORDS DEPARTMENT, 599 LEXINGTON AVENUE, 29TH FLOOR, NEW YORK, NY, 10022-7650, US

(21) Appl. No.: 10/699,094

(22) Filed: Oct. 31, 2003

(30) Foreign Application Priority Data
Oct. 31, 2002 (DE) 102 51 209.4

(51) Int. Cl. G10L 11/00

(52) U.S. Cl. 704/270

(57) ABSTRACT

The invention relates to a microphone system. By this is understood a microphone, be it a cable-bound or a wireless microphone, having a system connected thereto for processing the signals recorded with the microphone. The object of the present invention is to avoid the above-mentioned disadvantages and to simplify the adjustment of an entire acoustic system of a building. A microphone system, preferably a wireless microphone system, which is equipped with a speech recognition system which is able to analyse the speech signals transmitted via the microphone system at least to some extent in accordance with predetermined terms, words or contents, wherein the recognised terms, words or contents are used to perform a control function of the microphone system and/or of the transmission behaviour of the electroacoustic system connected to the microphone system.

CROSS-REFERENCE TO RELATED APPLICATION

This application claims priority of German Application No. 102 51 209.4, filed Oct. 31, 2003, the complete disclosure of which is hereby incorporated by reference.

### BACKGROUND OF THE INVENTION

a) Field of the Invention

The invention relates to a microphone system. By this is understood a microphone, be it a cable-bound or a wireless microphone, having a system connected thereto for processing the signals recorded with the microphone.

b) Description of the Related Art

Such microphones are already known in many different embodiments and are also used in very different areas.

One of these areas of use is provided in particular in theatres, concert halls, conference halls or the like, i.e. in buildings in which presentations take place or microphones are used in order to relay a speech from a speaker to the loudspeaker so that all the people present in a hall can have a good acoustical perception of this presentation or speech.

If such premises are equipped with a microphone system, a plurality of technical adjustments to the entire microphone system itself are always required, however more to the short-distance/close-range processing units by means of which the acoustic signals coming from the microphone are processed, recorded or transmitted in a normal manner.

Thus, for example, frequently in the case of speech or singing, by using mixing consoles the individual microphone has to be tuned in quite a specific manner or quite specific response modifications have to be performed on provided equalisers. Feedback reduction systems are set to a specific value. Twin T-filters, muting thresholds are adjusted etc.

For this it is necessary for the respective individual microphone systems to be concretely used in a so-called test cycle by a person so that then a technician can perform the desired modifications by said person carrying out commands from a producer or a sound technician, for example.

It is obvious that such a tuning of the microphone system or the entire acoustic system is very expensive. The complexity increases in particular in the case of very large theatres and congress halls in which a plurality of microphones and a plurality of acoustic systems, such as loudspeakers, are used.

The primary object of the present invention is to avoid the above-mentioned disadvantages and to simplify the setting of an entire acoustic system of a building.

In accordance with the present invention, a microphone system, such as a wireless microphone system, comprises speech signals transmitted by the microphone system and a speech recognition system. The speech recognition system is able to analyze the speech signals transmitted by the microphone system at least to some extent in accordance with predetermined terms, words or contents. The terms, words or contents recognized by the speech recognition system are used to perform a control function of the microphone system and/or of the transmission behavior of an electroacoustic system connected to the microphone system.

### DESCRIPTION OF THE PREFERRED EMBODIMENTS

With the achievement according to the invention, the microphone system is coupled with a speech recognition system. This speech recognition system also receives from the microphone system those signals which are inputted via the microphone, thus e.g. the usual speech signals or also other signals which can be electrically and/or acoustically triggered by the microphone itself.

If an acoustic tuning of a room is to be performed with the microphone system according to the invention, the producer, sound technician or the person responsible for tuning the individual acoustic systems can speak specific commands directly into the microphone, so that when the speech recognition system understands these commands they simultaneously also trigger a control function in the electroacoustic system connected to the microphone system.

In this case a control function means not only, for instance, switching on or off specific parts of the electroacoustic system, but also setting its parameters.

Thus, for example, a control function may consist in controlling specific delay lines so that an undesired Hall function inside a building is avoided, but on the other hand the sound from the speaker himself, and also that from the loudspeaker, simultaneously arrive at a specific location.

Moreover, limiter circuits, control computers, equalisers, feedback reduction systems, twin T-filters, muting thresholds, but also the frequency settings of transmitter or receiver systems can be set by means of the microphone system.

Furthermore, it is also possible for the speech recognition system also to be used to recognise commands by means of which the further infrastructure of the affected room can also be adjusted, e.g. the light controls, a stage mechanism or parts thereof, lifting platforms, windows, ventilation devices, etc.

So that the speech recognition system is not permanently in operation and inadvertently activates a control, it is advantageous if the activation of the speech recognition system itself is possible also by the microphone by, for example, a quite special command being outputted by speech or with another signal, or the microphone having a key or a similar device with which an electrical signal or an acoustic signal is triggered, which is then used to activate the speech recognition system.

The speech recognition system itself can be integrated in the entire microphone system or in its connected electroacoustic system parts, however it may also be accommodated in a separately connected device, which is connected to the output of the microphone, so as to perceive the acoustic signals recorded by the microphone and to evaluate them with respect to their content.

Furthermore, it is advantageous if the speech recognition system is equipped with a term and command database, so that when a specific term, word or other acoustic signals are recognised, a precise association with a command, more precisely a control command, is carried out, which then in turn is used to control the transmission behaviour of the part of the electroacoustic system which is affected.

The advantage of the invention is in particular that an already provided microphone, which is in any case required in the room, is also used to record the respective control commands and to transmit them to the speech recognition system, which may also result in the person who would like to perform the tuning itself, such as e.g. a producer, sound technician etc, moving through the room and, without the assistance of a helper, to a large extent being able to tune the individual electroacoustic parts of the entire acoustic reproduction system and also of the microphone itself by speech input to the parameters which he desires.

The microphone system according to the invention can also be advantageously used during a presentation, for if, for example, a device itself, such as e.g. a stage, a high platform or the like, is controlled by means of specific word or song frequencies, this control can take place exactly at the same time as the desired event, which in a quite special manner achieves effects which were previously not possible.

While the foregoing description and drawings represent the present invention, it will be obvious to those skilled in the art that various changes may be made therein without departing from the true spirit and scope of the present invention.

1-8. (Cancelled)

9. A microphone system, such as a wireless microphone system, comprising:
speech signals transmitted by the microphone system; and
a speech recognition system which is able to analyze speech signals transmitted by said microphone system at least to some extent in accordance with predetermined terms, words or contents;
terms, words or contents recognized by said speech recognition system used to perform a control function of the microphone system and/or of the transmission behavior of an electroacoustic system connected to the microphone system.

10. A microphone system according to claim 9, wherein the speech recognition system is constructed in the microphone receiver of a wireless microphone system which consists of a microphone transmitter and a microphone receiver.

11. A microphone system according to claim 9, wherein the speech recognition system is integrated in a mixing console.

12. A microphone system according to claim 9, wherein the speech recognition system is contained as an independent unit device connected between the microphone and receiver output and wherein said device relays the recognized commands by standardized control information to following devices to influence the electroacoustic transmission properties.

13. A microphone system according to claim 9, wherein the speech recognition system can also use the recognised commands to control other electroacoustic transmission properties, such as e.g. the light control, the stage mechanisms (lifting platforms), windows, ventilation devices, inside a theater or opera house.

14. A microphone system according to claim 9, the speech recognition system is only activated by a special command and/or an additional electric or acoustic signal.

15. A microphone system according to claim 9, wherein the microphone is provided with a device by which a signal for activating the speech recognition system can be triggered.

16. A microphone system according to claim 15, wherein the triggering device is disposed concealed in the microphone or its transmitting or receiving device so that unintentional triggering is impossible during the normal operating process.
